(19) United States
(12) Patent Application Publication
(10) Pub. No.: US 2012/0111261 A1
(43) Pub. Date: May 10, 2012

(54) Wheelchair access space reservation device (lift guard) for vehicles equipped with wheelchair lifts

(76) Inventors: Jeffrey L. Schmitt, Port Townsend, WA (US); James L. Schmitt, Port Townsend, WA (US)

(21) Appl. No.: 13/317,332

(22) Filed: Oct. 13, 2011

Related U.S. Application Data
(60) Provisional application No. 61/456,371, filed on Nov. 5, 2010.

(51) Int. Cl. B60Q 1/00

(52) U.S. Cl. 116/28 R

(57) ABSTRACT

A device for reservation of access space for a vehicle equipped with a wheelchair ramp includes an attachment mechanism for attachment of the device to the vehicle, an arm coupled to the attachment mechanism and a caution sign carried by or otherwise present on the arm. The arm is moveable from a stowed condition to an extended, deployed position. The arm is carried in the stowed condition while the vehicle is driven over the road. The arm is placed in the deployed, extended position when the vehicle is parked to thereby preserve space adjacent to the vehicle for access to the wheelchair ramp. In some embodiments the arm is telescoping in design. The caution sign may be lighted. The arm can also be moved to the deployed position by means of a motor driven by vehicle power.

### PRIORITY

This application claims priority under 35 U.S.C. §119 to U.S. provisional application Ser. No. 61/456,371 filed Nov. 5, 2010, the content of which is incorporated by reference herein.

### FIELD

This invention relates to vehicles equipped with a wheelchair lift and more particularly relates to a device for preserving access space to the side of the vehicle when the vehicle is parked. The device of this invention enables convenient access to the wheelchair lift and prevents the access to the lift from becoming blocked due to other cars being parked too close to the vehicle.

### BACKGROUND

This invention solves a need to preserve access space around vehicles equipped with a wheelchair lift, and specifically to preserve space around the lift area of the vehicle so that a passenger confined to a wheelchair can access the lift. This need for preservation of access space arises after the vehicle is parked. Wheelchair lifts are normally installed on the passenger side of the vehicle. If an adjacent parking space on the passenger side of the vehicle becomes occupied while the passenger is away from the vehicle (e.g., shopping at a store), the passenger often cannot access the lift and re-enter their vehicle until the driver of the adjacent vehicle comes back to their car and drives away. This can be extremely inconvenient to the passenger.

### SUMMARY

The inventors' solution is to provide an inventive device for reservation of access space for a vehicle equipped with a wheelchair lift. The device includes an attachment mechanism for attachment of the device to the vehicle, an arm coupled to the attachment mechanism, and a caution sign carried by the arm. The arm is moveable from a stowed condition to a deployed position. The arm is maintained in the stowed condition while the vehicle is driven over the road. The arm is placed in the deployed condition, projecting out away from the vehicle on the side of the vehicle where the wheelchair lift is located when the vehicle is parked to thereby preserve space adjacent to the vehicle for access to the wheelchair lift. The sign warns drivers to not park in the adjacent parking space and serves to hinder any attempt to park in the adjacent parking space.

The location of the attachment mechanism will typically be either the rear of the vehicle or the passenger side of the vehicle. Various possible attachment mechanisms are possible and a suitable one will be used depending on the configuration of the vehicle, such as whether it has a single rear door, double rear doors, curved doors, a tire rack on the rear door, etc. The attachment mechanism can include various attachment devices including straps, brackets, conventional hardware fasteners, clamps and the like which connect to features on the rear of the vehicle such as door jambs, door edges, and the like. The attachment mechanism may require additional custom hardware components, examples of which are described below. Velcro™ or even suction cups can be used as an attachment mechanism to connect the device to the vehicle.

The arm of the device may be one piece or alternatively two or more pieces which telescope or nest relative to each other. The arm is deployed to a condition extending to the side of the vehicle at the time of use such that it extends out a sufficient distance to the passenger side of the vehicle from the rear of the vehicle, such as 6 feet or so. This arm may include an optional vertical support or leg at the end thereof to maintain the arm in an approximately horizontal attitude when the arm is deployed. The arm optionally includes reflective material. The arm is preferably deployed at a height of at least 36 inches off the ground for maximum visibility to other drivers.

The device includes a caution sign denoting its purpose to preserve access, such as CAUTION WHEELCHAIR ACCESS or the like. The sign (which could contain exclusively non-verbal sign elements or indicia in lieu of or in additional to verbiage) can be incorporated into a sleeve for the arm. When not in use, the arm and optional vertical support collapse and nest in a stored position on the rear of the vehicle (e.g., within the sleeve) and do not protrude to the side of the vehicle, so that the vehicle can be safely driven in the usual manner over the road. The device is deployed when the vehicle is parked so as to preserve access space to the passenger side of the vehicle for the wheelchair lift allowing the wheelchair-bound passenger to re-enter the vehicle without any hindrance from adjacent vehicles. Thus, the device preserves roughly six feet of space to the passenger side of the vehicle which is needed for the wheelchair passenger to access the lift and re-enter their vehicle, the exact amount of space depending on the dimensions of the arm. This dimension can of course vary depending on the size of the lift, size of wheelchair, and other considerations.

The arm, in the stowed or non-deployed condition, is able to be pivoted so that it can be moved out of the way to allow access to the right hand rear door in a vehicle equipped with double rear doors. The device can also be deployed by the wheelchair passenger and does not require any tools to deploy. The device can also be deployed by means of an electric motor, associated drive mechanism, and an on/off switch.

In another aspect, a method of preserving access space for a vehicle equipped with a wheelchair ramp is described, comprising the steps of: (a) stowing an access space reservation device on or in the vehicle while the vehicle is driven over the road, the device including an extendable arm and a caution sign, (b) upon parking the vehicle, deploying the extendable arm such that the arm is extended away from the vehicle a sufficient distance to preserve access space for the wheelchair ramp, and (c) displaying the caution sign.

The following description and figures of exemplary embodiments will further illustrate presently preferred embodiments of the invention.

### BRIEF DESCRIPTION OF THE DRAWINGS

FIG. 1 is an isometric view of the inventive wheelchair access space reservation device shown in a deployed condition thereby preserving space adjacent to the vehicle for easy access to the wheelchair lift while the vehicle is parked.

FIG. 1A is an exploded view of a first embodiment of the wheelchair access space reservation device.

FIG. 1B is an exploded view of a second embodiment of the wheelchair access space reservation device.

FIG. 1C is an exploded view of a third embodiment of the wheelchair access space reservation device.

FIG. 1D is an exploded view of a fourth embodiment of the wheelchair access space reservation device.

FIGS. 2A, 2B and 2C are exploded views of details of the embodiments of FIGS. 1A-1D.

Model TR, FIG. 1D

FIG. 3 is a more detailed isometric view of the fourth embodiment of FIG. 1D.

FIG. 4 is an elevation view of the embodiment of FIGS. 1D and 3 with the device shown in a deployed condition.

FIG. 5 is an exploded, isometric view of the left-hand end of the embodiment of FIG. 4, showing the mounting attachment mechanism of the design that attaches the device to a tire rack on the rear door of the vehicle.

FIG. 6 is an exploded, isometric view of the embodiment of FIG. 4, showing the sleeve and the vertical support or leg extended to the vertical position as it would be when the device is deployed.

FIG. 7 is a detailed view of the brackets of FIG. 5 that attach the device to a tire rack.

FIG. 8 is a detailed view of the middle portion of the design of FIG. 4 showing a locking pin that locks the telescoping arm into an extended condition when the device is deployed.

FIG. 9 is a cross-section through the device of FIG. 4 along the lines 9-9 of FIG. 4.

FIG. 10 is a cross-section through the device of FIG. 4 along the lines 10-10 of FIG. 4.

FIG. 11 is a cross-section through the device of FIG. 4 along the lines 11-11 of FIG. 4.

Model SSD, FIG. 1C

FIG. 12 is an exploded, isometric view of the embodiment of FIG. 1C (model “SSD”).

FIG. 13 is an exploded, isometric view of the embodiment of FIG. 12 showing the attachment mechanism detail of FIG. 12.

FIG. 14 is an exploded, isometric view of the embodiment of FIG. 12 showing a second part of the attachment mechanism device indicated by the circle “FIG. 14” in FIG. 12.

FIG. 15 is a cross-section of the device of FIG. 12 taken along the lines 15-15 of FIG. 21.

FIG. 16 is a cross-section of the device of FIG. 12 taken along the lines 16-16 of FIG. 21.

FIG. 17 is a cross-section of the device of FIG. 12 taken along the lines 17-17 of FIG. 21.

FIG. 18 is a detail of the device of FIG. 12 showing the locking pin that secures the telescoping arm in the deployed condition.

FIG. 19 is a cross-section of the device of FIG. 12 taken along the lines 19-19 of FIG. 21.

FIG. 20 is a cross-section of the device of FIG. 12 taken along the lines 20-20 of FIG. 21.

FIG. 21 is an elevation view of the device of FIG. 12 in the deployed condition.

Model SDD

FIG. 22 is an exploded, isometric view of the embodiment of FIG. 1B (model “SDD”).

FIG. 23 is an exploded, isometric view of the embodiment of FIG. 22 showing the detail of FIG. 22 indicated by the circle “FIG. 23” in FIG. 22.

FIG. 24 is an exploded, isometric view of the embodiment of FIG. 22 showing a second detail of the device at the left hand end of the device indicated by the circle “FIG. 24” in FIG. 22.

FIG. 25 is a cross-section of the device of FIG. 22 taken along the lines 25-25 of FIG. 31.

FIG. 26 is a cross-section of the device of FIG. 22 taken along the lines 26-26 of FIG. 31.

FIG. 27 is a cross-section of the device of FIG. 22 taken along the lines 27-27 of FIG. 31.

FIG. 28 is a detail of the device of FIG. 22 showing the locking pin that secures the telescoping arm in the deployed condition.

FIG. 29 is a cross-section of the device of FIG. 22 taken along the lines 29-29 of FIG. 22.

FIG. 30 is a cross-section of the device of FIG. 22 taken along the lines 30-30 of FIG. 31.

FIG. 31 is an elevation view of the device of FIG. 22 in the deployed condition.

Model SCD

FIG. 32 is an exploded, isometric view of the embodiment of FIG. 1A (model “SCD).

FIG. 33 is an exploded, isometric view of the embodiment of FIG. 32 showing the detail of FIG. 32 indicated by the circle “FIG. 33” in FIG. 32.

FIG. 34 is an exploded, isometric view of the embodiment of FIG. 32 showing a second detail of the device indicated by the circle “FIG. 34” in FIG. 32.

FIG. 35 is a cross-section of the device of FIG. 32 taken along the lines 35-35 of FIG. 41.

FIG. 36 is a cross-section of the device of FIG. 32 taken along the lines 36-36 of FIG. 41.

FIG. 37 is a cross-section of the device of FIG. 32 taken along the lines 37-37 of FIG. 41.

FIG. 38 is a detail of the device of FIG. 32 showing the locking pin that secures the telescoping arm in the deployed condition.

FIG. 39 is a cross-section of the device of FIG. 32 taken along the lines 39-39 of FIG. 41.

FIG. 40 is a cross-section of the device of FIG. 32 taken along the lines 40-40 of FIG. 41.

FIG. 41 is an elevation view of the device of FIG. 32 in the deployed condition.

FIGS. 42A and 42B are two views of a spring which connects to the vertical leg or support to help extend the leg into the vertical condition so that it supports the end of the arm.

FIGS. 43A-43C are orthographic views of an optional protective cover for a ratchet that is used with the strap 30/35 in the embodiments of FIGS. 1A, 1B and 1C.

FIG. 44 is an isometric view of a motorized embodiment in which the deployment of the device is achieved by a motor and drive mechanism.

FIG. 45 is an isometric view of an alternative configuration of the motorized drive mechanism for deploying the device.

### DETAILED DESCRIPTION OF PREFERRED EMBODIMENTS

Overview

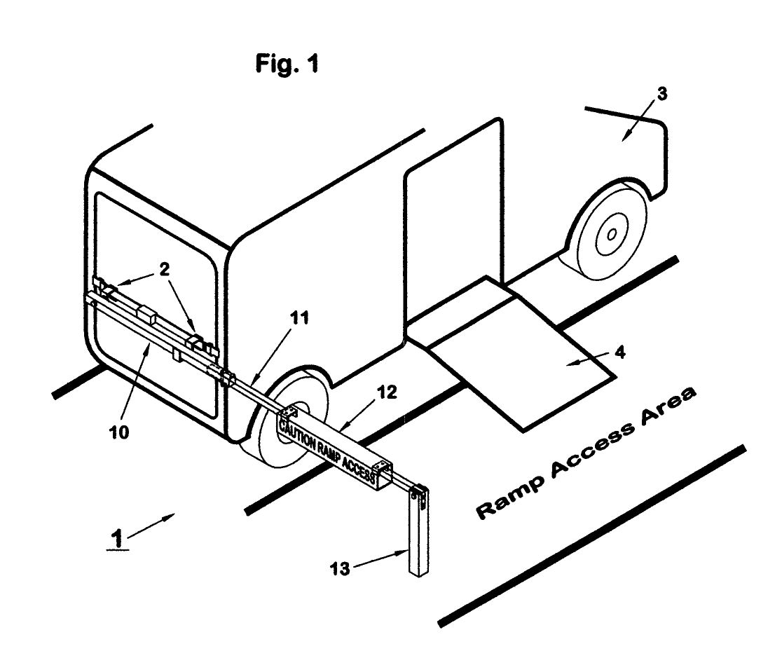

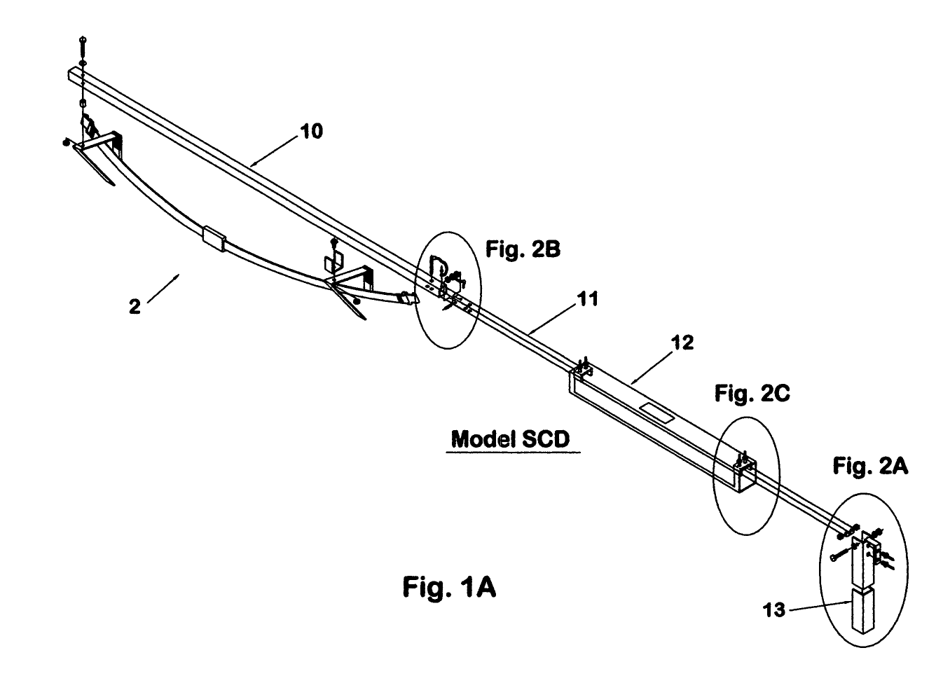

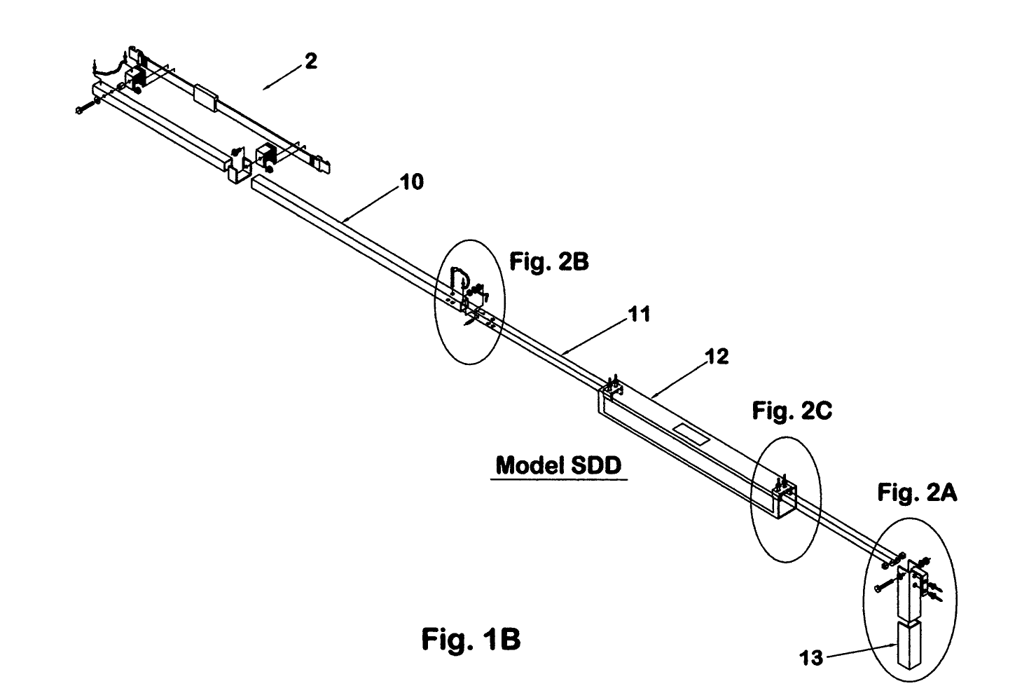

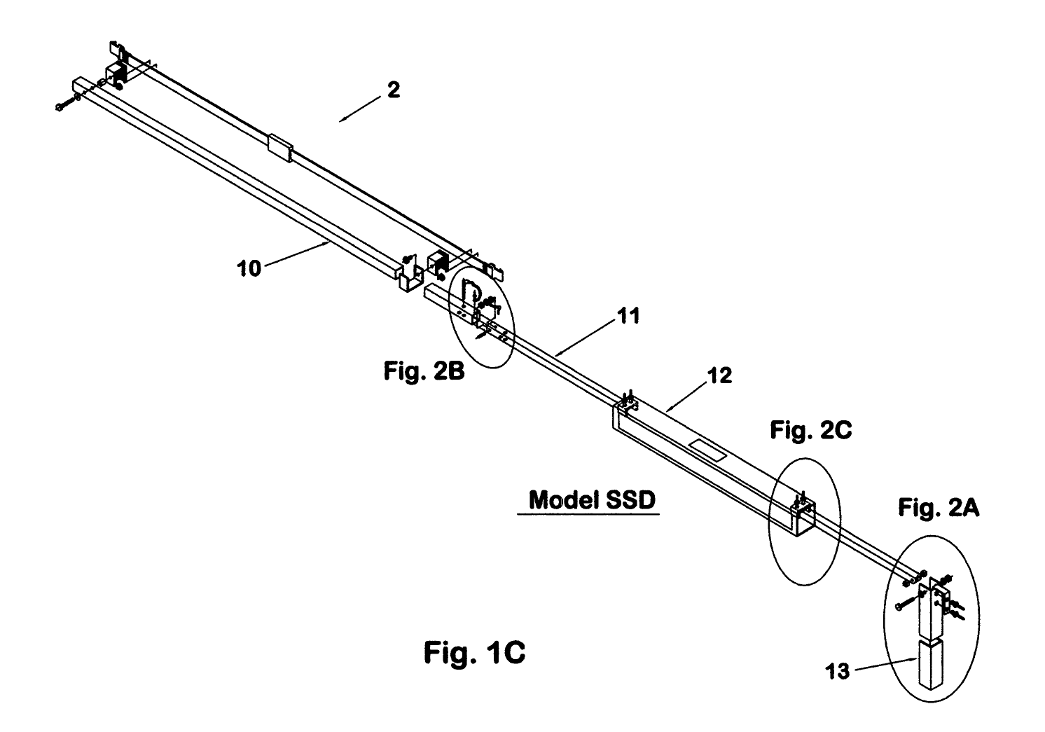

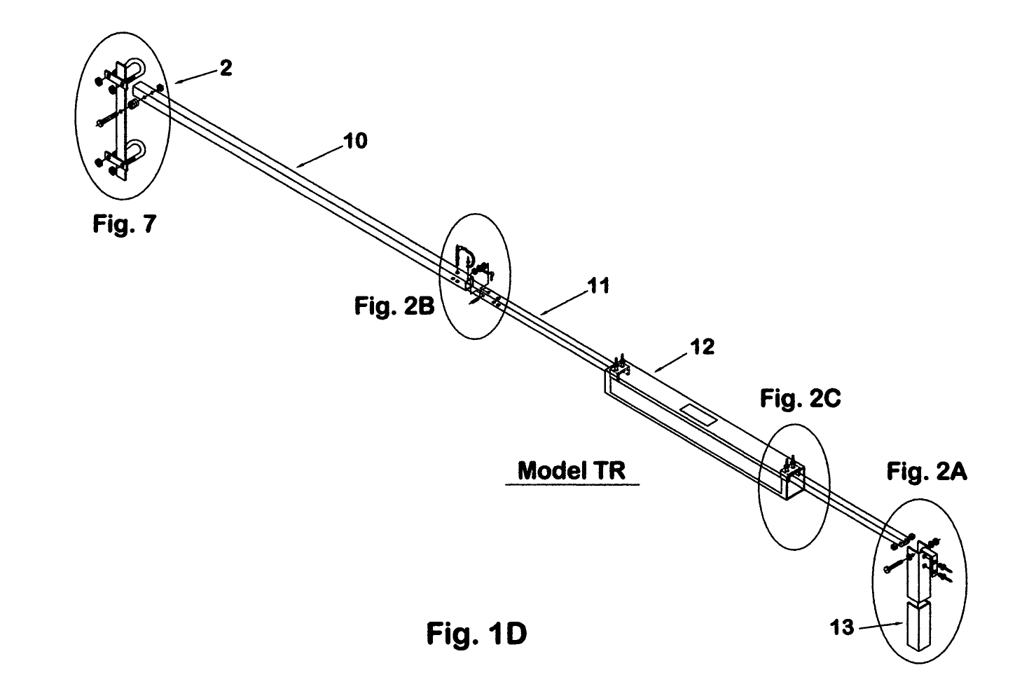

FIG. 1 shows an inventive wheelchair access space reservation device 1, referred to as a “lift guard” for short, in a deployed condition. The lift guard 1 includes an attachment mechanism 2 for attaching the lift guard 1 to a vehicle 3 equipped with a wheelchair lift 4. While the vehicle 3 is being driven down the road, the lift guard 1 is in a stowed or nested position. After the vehicle 3 is parked, the user operates the arm 10 of lift guard to deploy it to an extended position as shown in the figure. In the deployed position, the arm 10 of the lift guard 1 extends out away from the vehicle where it serves to reserve sufficient space to the side of the vehicle as shown in the figure such that the wheelchair-bound passenger can access the wheelchair lift, free from any encroachment from adjacent vehicles. The lift guard 1 includes a caution sign (on a sleeve 12) that serves to warn drivers not to park adjacent to the vehicle 3. The lift guard in the deployed condition extends physically away from the vehicle 3 a sufficient distance, such as roughly six feet or so, to physically block another car from parking immediately next to the vehicle 3. Thus, the lift guard serves to preserve access space for the wheelchair lift while the vehicle is parked.

The embodiments described below have several common features. They include an arm 10 (in the illustrated embodiment is telescoping and includes a slide arm 11 which nests within the arm 10) which extends from a retracted (nested) position to an extended (deployed) condition. A sleeve 12 which receives the arm carries a suitable warning sign such as CAUTION WHEELCHAIR ACCESS or the like. The sleeve 12 rides freely over the arm 10 in the illustrated embodiment. The device further includes an optional vertical support or leg 13 which is attached to the end of the arm 10 and serves to support the distal end of the arm and maintains the arm in an approximately horizontal attitude when the arm 10/11 is deployed. The vertical support or leg 13 is optional; if the arm is sufficiently robust it will project out to the side of the vehicle and will not require vertical support at its distal end. The device 1 also includes attachment mechanism 2 to attach the arm 10 to the vehicle; this attachment mechanism will vary depending on the construction of the vehicle and how and where the lift guard is mounted to the vehicle. Four different attachment mechanism designs are described in the drawings and several more options are still possible.

Parts Description and Operation

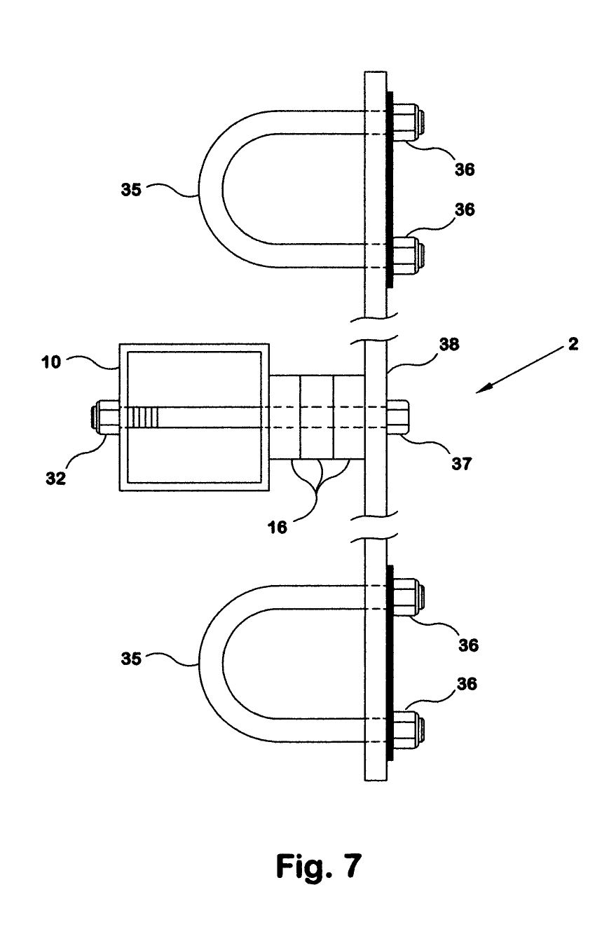

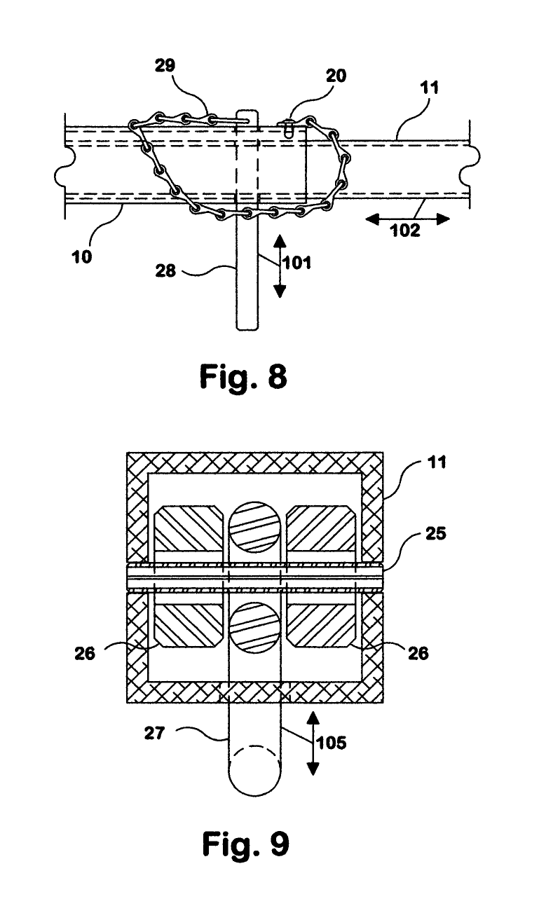

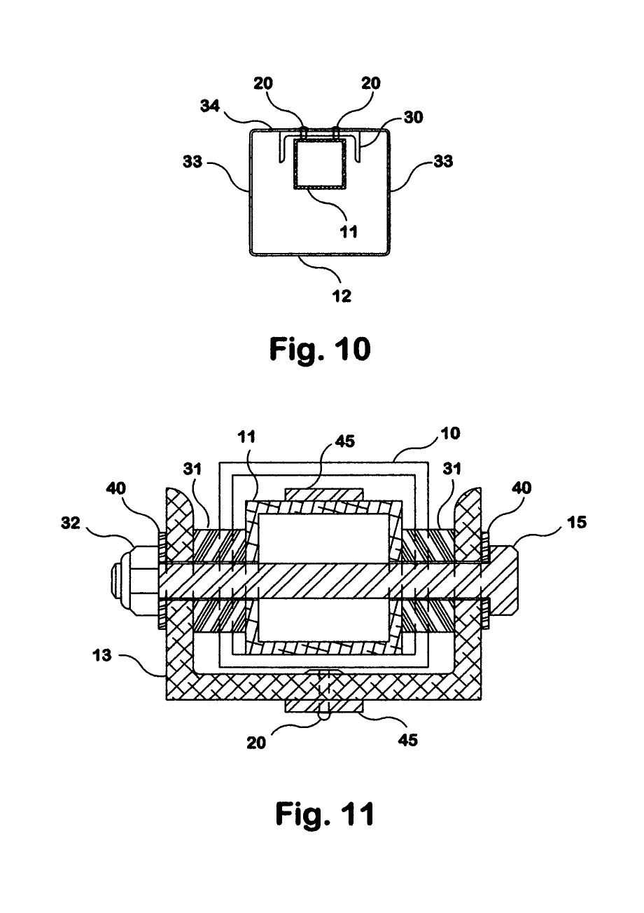

Model TR (FIGS. 1D, 2A-2C, 3-11)

This model will install on any make or model of van with a tire rack on the left side back door. The telescoping arm 10 of the Lift Guard rotates up to access the right side back door.

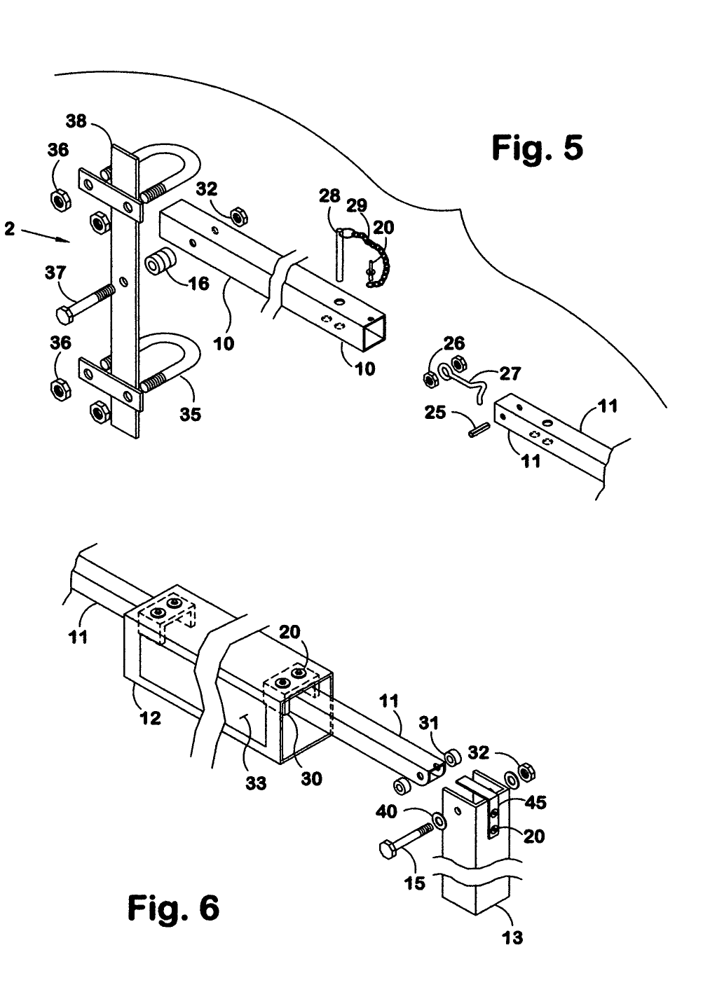

The attachment mechanism 2 includes a pair of U-bolts 35 with nuts 36 (FIG. 5, 7) which are used to attach a mounting bar 38 to an existing tire rack (not shown) of ramp-modified van.

A bolt 37, spacers 16, and a nut 32 (FIG. 5) hold and allow the telescoping arm 10 to rotate up (operation 106), on the mounting bar 38 to thereby provide access to the right-hand door of a van equipped with dual rear doors.

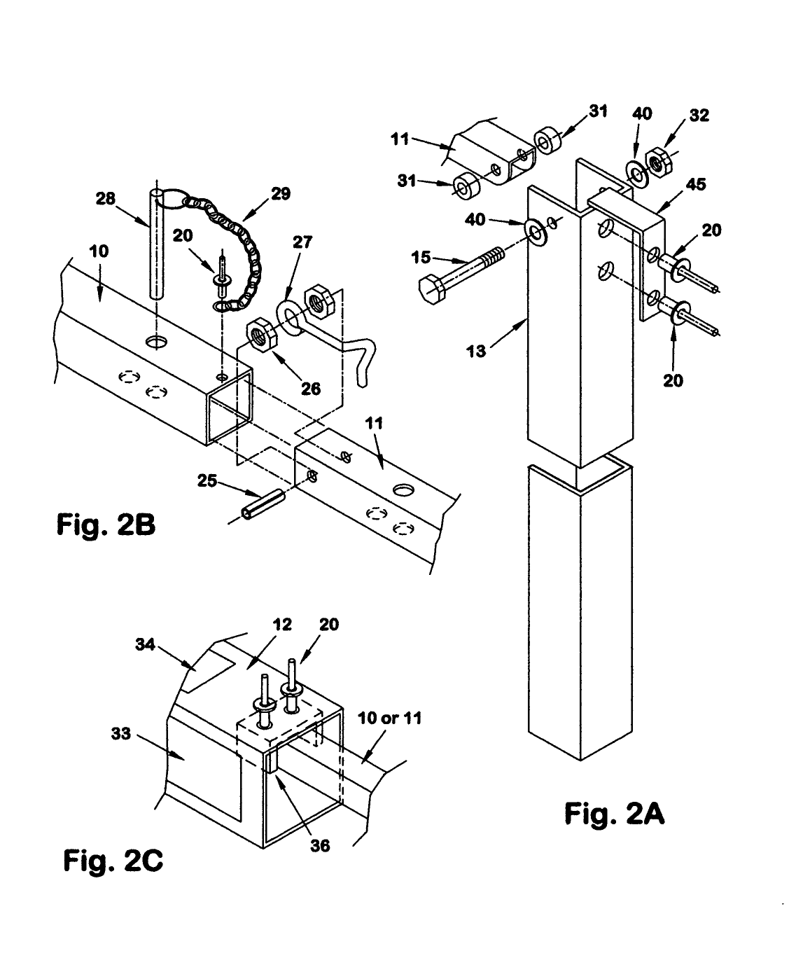

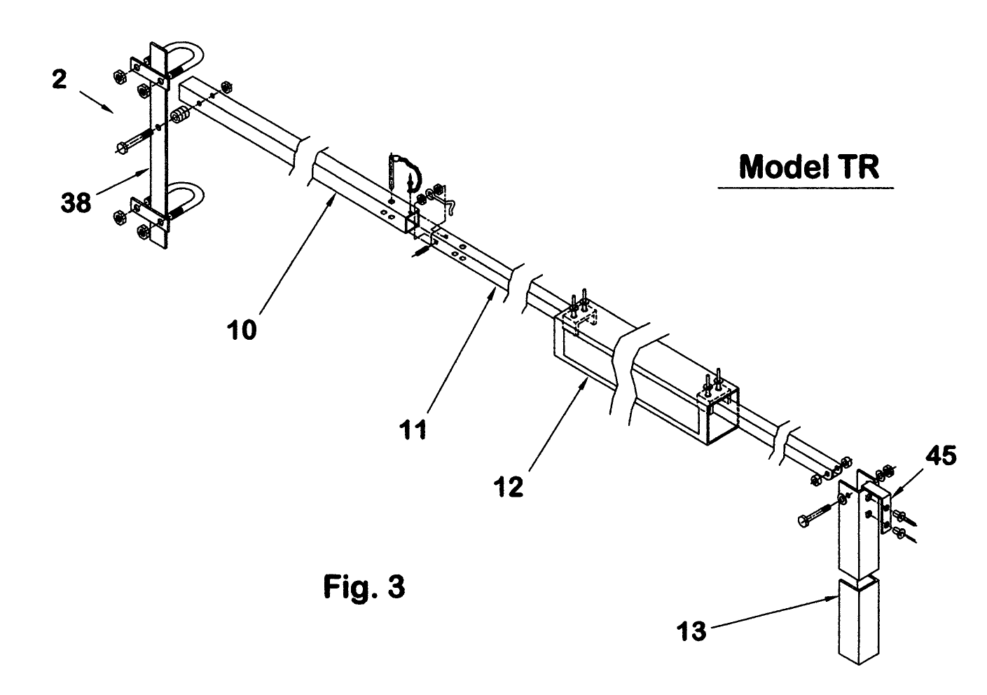

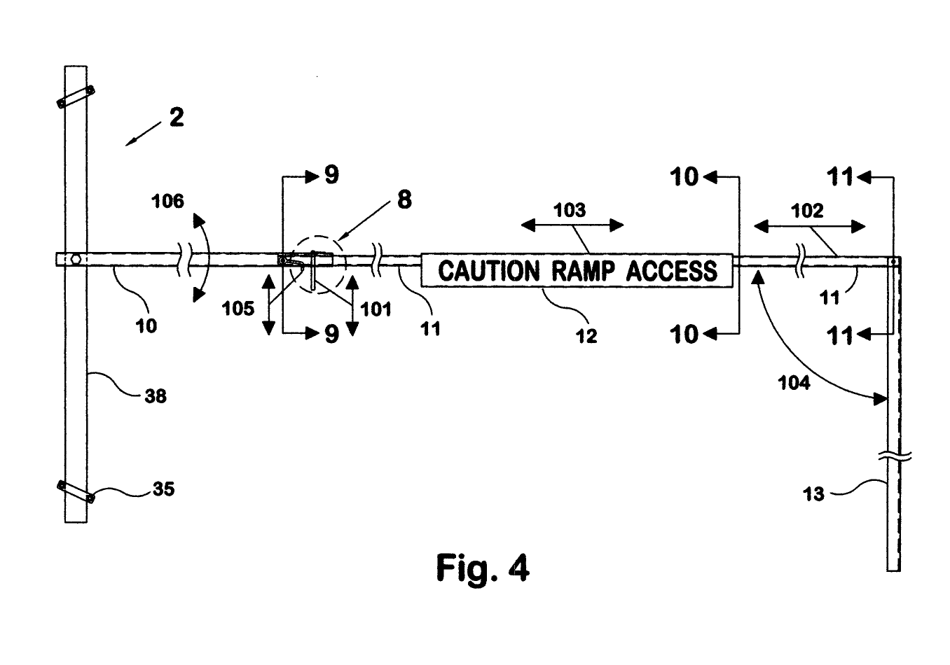

Referring to FIG. 2B, a rivet 20 and a chain 29 attach a locking pin 28 to the telescoping arm 10. The arm 10 includes two pieces, the main arm 10 and a telescoping slide arm 11 which nests inside the arm 10 when the device is in a stowed or nested condition and which slides out to a fully extended position when the device is deployed as shown in FIG. 4.

Referring to FIGS. 2B and 4, to deploy the telescoping slide arm 11, the user pulls the locking pin 28 up, (operation 101), to move slide arm 11 out, (operation 102), from end of pivot arm 10. Nuts 26 and stop pin 27 rotate on pin 25 (operation 105), inside at the left end of slide arm 11. Stop pin 27 drops, (operation 105), into a hole at the end of pivot arm 10 to stop the slide arm from coming out of the end of the pivot arm 10.

Referring to FIG. 2C, rivets 20 and guide brackets 36 attach to the ends of sleeve 12 to center the sleeve 12 on the pivot (10) or slide (11) arms.

Caution signs (e.g., “CAUTION WHEELCHAIR ACCESS”) 34 and 33 are attached to the sleeve 12.

The sleeve 12 is moved by the user from the pivot arm 10 to the slide arm 11 as shown in FIG. 4 when the device is deployed for use, operation 103 shown in FIG. 4.

Referring to FIG. 2A, a bolt 15, a washer 40, and a spacer 31 and a nut 32 hold the vertical support or leg 13 to the right end of slide arm 11. A spring 45 is fastened to the upper portion of the leg 13 using rivets 20 to assist in deploying the leg 13. Spring 45 opens and holds the leg 13 in vertical position with device in the deployed condition (operation 104 in FIG. 4).

Once the slide arm 11 is extended and the vertical leg 13 is moved to the position shown in FIG. 4, the locking pin 28 is replaced (operation 101) to lock the slide arm to the main arm 10.

Model SSD (FIGS. 1C, 2A-2C, 12-21)

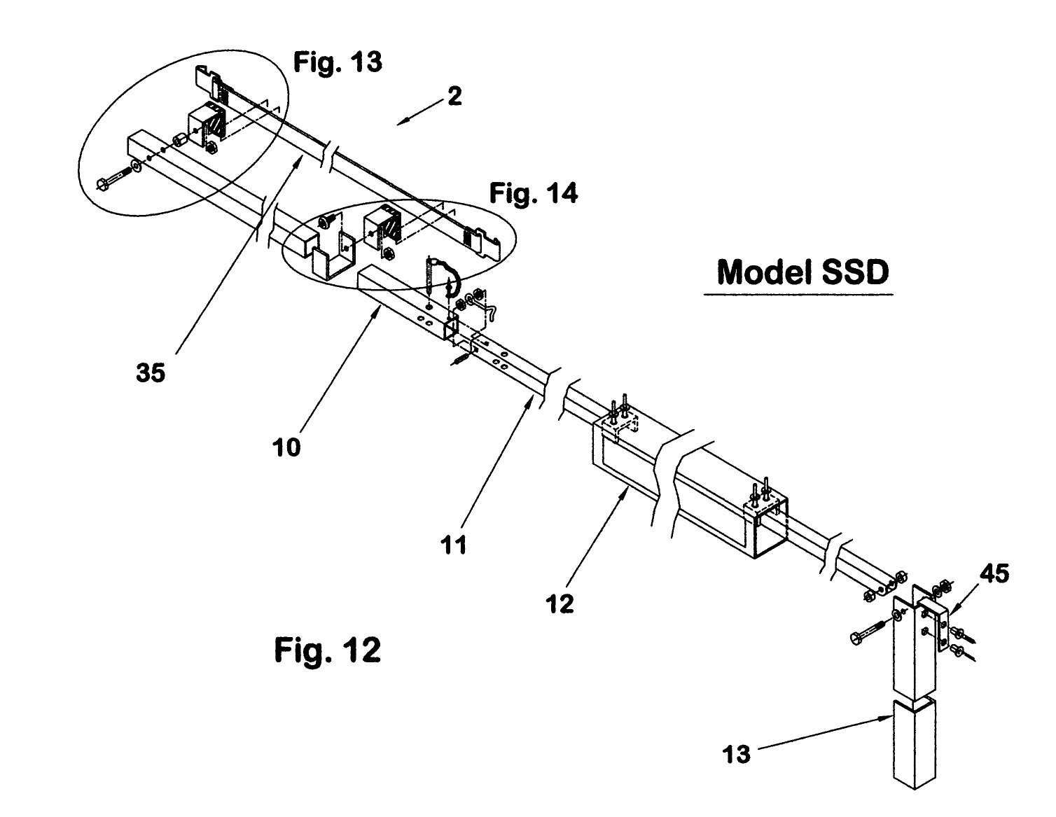

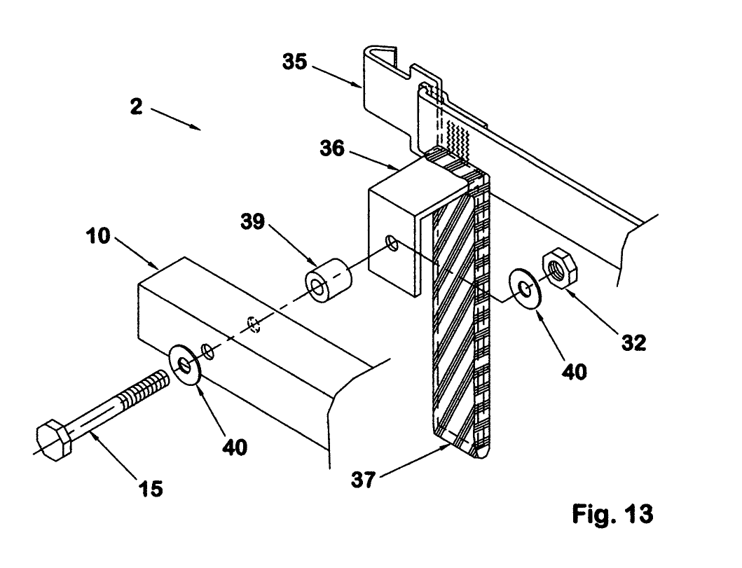

This model will install on any make or model of van with a single or horizontal split back door. An attachment mechanism 2 in the form of support bracket arrangement shown in FIG. 13 secures the device to the door of the van. The telescoping arm 10 rotates out of the support bracket (FIG. 13) to enable moving the sleeve (operation 103) to a deployed position. This embodiment is shown in exploded isometric view in FIG. 12, and in a deployed condition in an elevation view in FIG. 21.

Referring to FIG. 13, a bolt 15, a spacer 39, a washer 40, and a nut 32 let the pivot arm 10 rotate (operation 106, FIG. 21) on a mounting bracket 36, left end. A plastic coating 37 on the mounting bracket 36 protects the vehicle while a strap 35 holds the bracket 36 to the vehicle, e.g. by the ends of the strap 35 engaging with the edges of the vehicle doors.

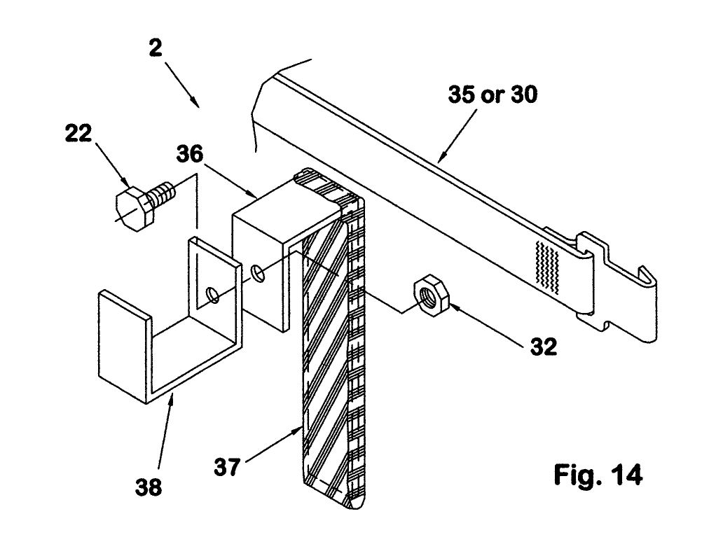

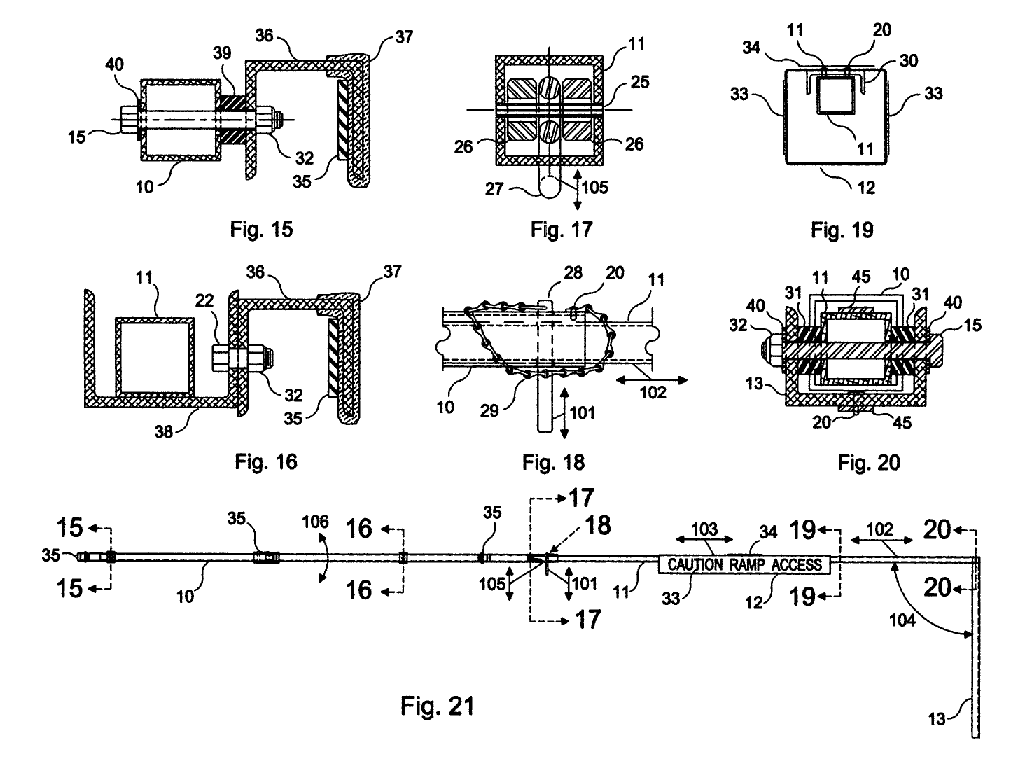

Referring to FIG. 14, a bolt 22 and a nut 32 hold a bracket 17 to second bracket 36, 37. The bracket 37 supports the pivot arm 10 at its right end. The strap 35 passes between the portions 36 and 37 of the bracket, as seen best in the cross-sectional views of FIGS. 15 and 16. FIG. 15 is a cross-section of the device of FIG. 12 taken along the lines 15-15 of FIG. 21. FIG. 16 is a cross-section of the device of FIG. 12 taken along the lines 16-16 of FIG. 21. FIG. 17 is a cross-section of the device of FIG. 12 taken along the lines 17-17 of FIG. 21. FIG. 18 is a detail of the device of FIG. 12 showing the locking pin that secures the telescoping arm in the deployed condition. FIG. 19 is a cross-section of the device of FIG. 12 taken along the lines 19-19 of FIG. 21. FIG. 20 is a cross-section of the device of FIG. 12 taken along the lines 20-20 of FIG. 21. FIG. 21 is an elevation view of the device of FIG. 12 in the deployed condition.

Referring to FIGS. 12 and 21, to deploy the telescoping slide arm 11, the user pulls the locking pin 28 up, (operation 101, FIG. 21), to move slide arm 11 out, (operation 102), from the end of pivot arm 10. Nuts 26 and stop pin 27 rotate on pin 25 (operation 105), inside at the left end of slide arm 11 as described above in conjunction with FIG. 2B. Stop pin 27 drops, (operation 105), into a hole at the end of pivot arm 10 to stop the slide arm from coming out of the end of the pivot arm 10.

Referring to FIG. 2C, rivets 20 and guide brackets 36 attach to the ends of sleeve 12 to center the sleeve 12 on the pivot (10) or slide (11) arms.

Caution signs in the form of warning labels (e.g., “CAUTION RAMP ACCESS”) 34 and 33 are attached to the sleeve 12 as shown in FIG. 2C.

The sleeve 12 is moved by the user from the pivot arm 10 to the slide arm 11 as shown in FIG. 21 when the device is deployed for use, operation 103 shown in FIG. 21.

Referring to FIGS. 2A and 20, a bolt 15, a washer 40, and a spacer 31 and a nut 32 hold the vertical support or leg 13 to the right end of slide arm 11. A spring 45 (see FIGS. 49A and 49B) is fastened to the upper portion of the leg 13 using rivets 20 to assist in deploying the leg 13. Spring 45 opens and holds the leg 13 in vertical position with device in the deployed condition (operation 104 in FIG. 21).

Once the slide arm 11 is extended and the vertical leg 13 is moved to the position shown in FIG. 21, the locking pin 28 is replaced (operation 101) to lock the slide arm 11 to the main arm 10.

Model SDD (FIG. 1B, 2A-2C, 22-31)

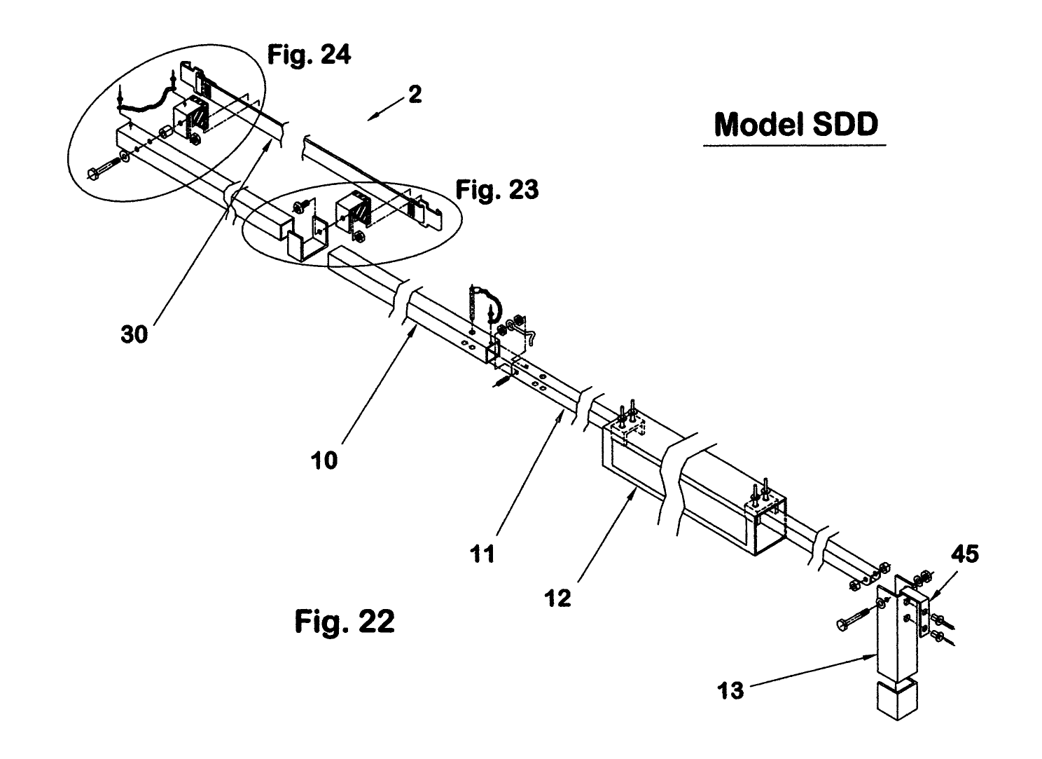

This model will install on any make or model of van with double vertical split back doors, and no tire rack. The telescoping arm 10/11 rotates up for access to the right side back door of the vehicle. This embodiment is shown in exploded isometric view in FIG. 22, and in a deployed condition in an elevation view in FIG. 31. The description of FIGS. 2A-2C also applies to this embodiment.

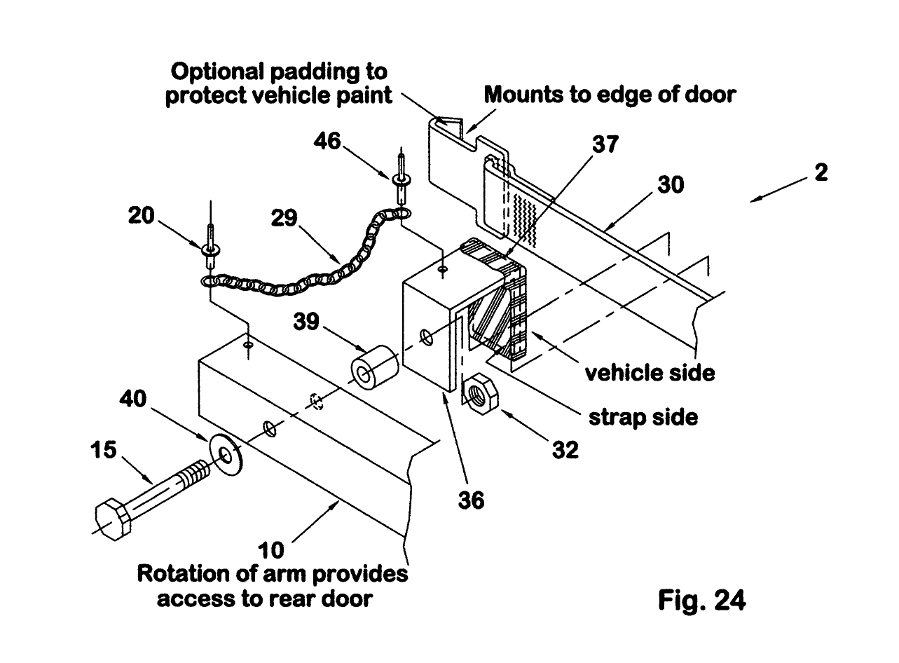

Referring to FIG. 24, the mounting attachment mechanism 2 includes a bolt 15, a spacer 39, a washer 40, and a nut 32 which let the pivot arm 10 rotate (operation 106) on a mounting bracket 36, left end. Plastic coating 37 on bracket 36 protects vehicle while a strap 30 holds the bracket (36) to the vehicle. A rivet (⅛″) 20, chain 29, and rivet (¼″) 46 stop the pivot arm 10 from over-rotation (operation 106 in FIG. 31).

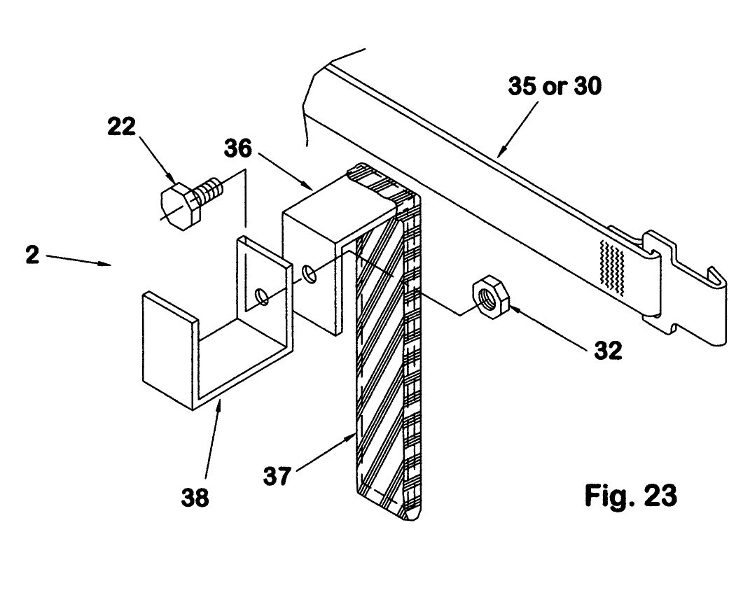

Referring to FIG. 23, a bolt 22 and a nut 32 hold a bracket 38 to a second bracket (36/37) to support the arm 10 at its right end.

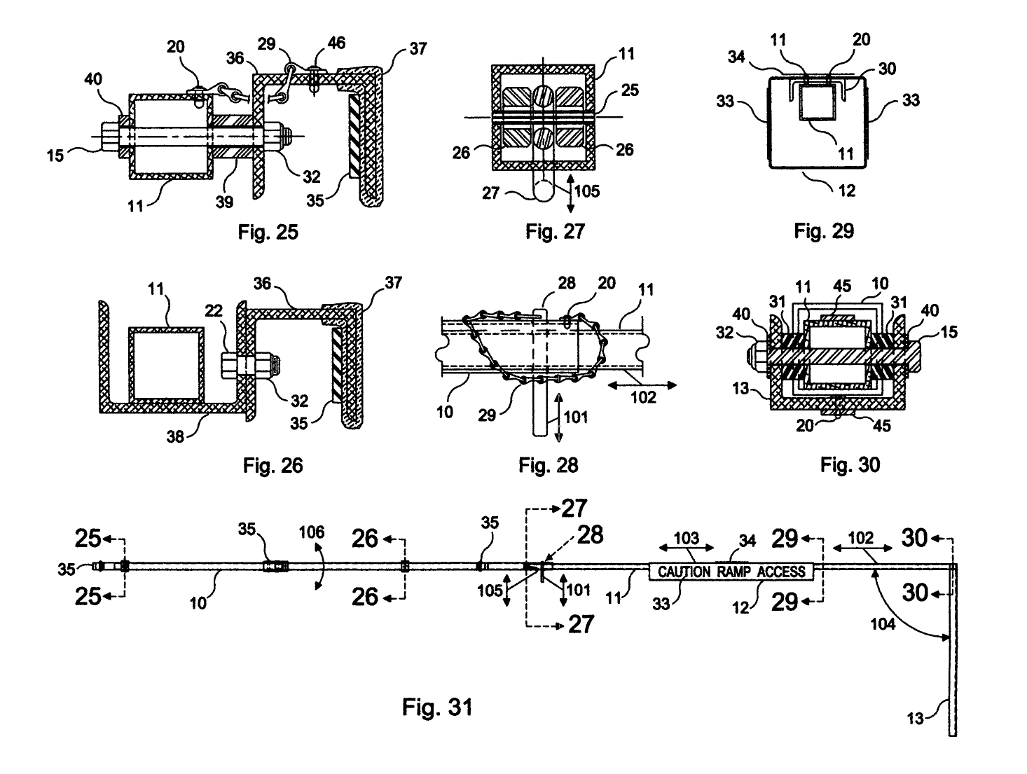

FIG. 25 is a cross-section of the device of FIG. 22 taken along the lines 25-25 of FIG. 31. FIG. 26 is a cross-section of the device of FIG. 22 taken along the lines 26-26 of FIG. 31. FIG. 27 is a cross-section of the device of FIG. 22 taken along the lines 27-27 of FIG. 31. FIG. 28 is a detail of the device of FIG. 22 showing the locking pin that secures the telescoping arm in the deployed condition. FIG. 29 is a cross-section of the device of FIG. 22 taken along the lines 29-29 of FIG. 31. FIG. 30 is a cross-section of the device of FIG. 22 taken along the lines 30-30 of FIG. 31. FIG. 31 is an elevation view of the device of FIG. 22 in the deployed condition. The construction of this embodiment is similar to that of the previously described embodiments. Like reference numbers refer to like elements in the various views. Therefore, a detailed description of these figures is not necessary and is omitted for the sake of brevity.

Model SCD (FIGS. 1A, 2A-2C, 32-41)

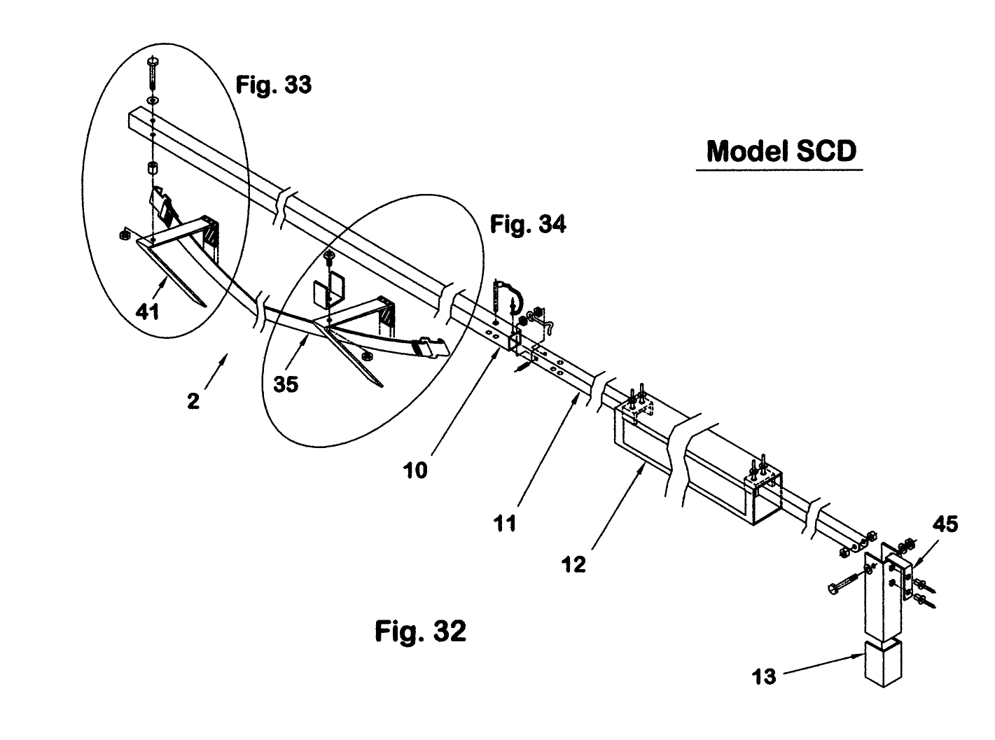

This model will install on any make or model of van with a single deep curved back door. The telescoping arm 10 rotates up and out of the support bracket (41) to deploy the sleeve 12. This embodiment is shown in exploded isometric view in FIG. 32, and in a deployed condition in an elevation view in FIG. 41. The description of FIGS. 2A-2C also applies to this embodiment.

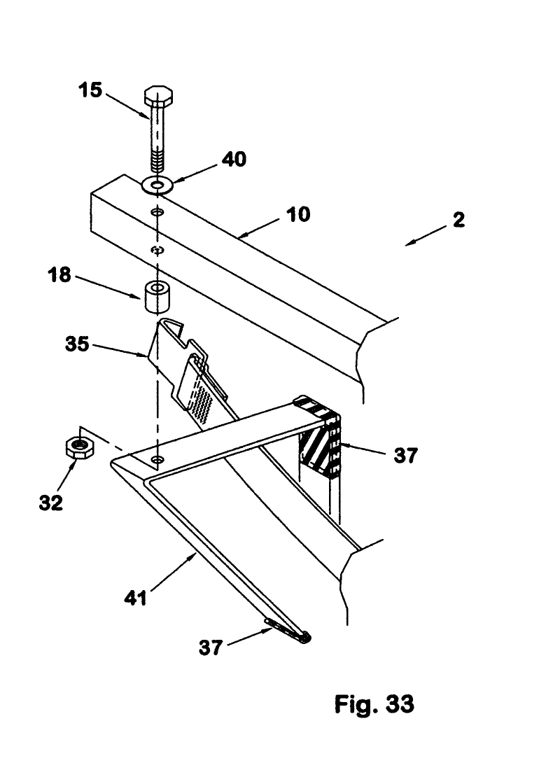

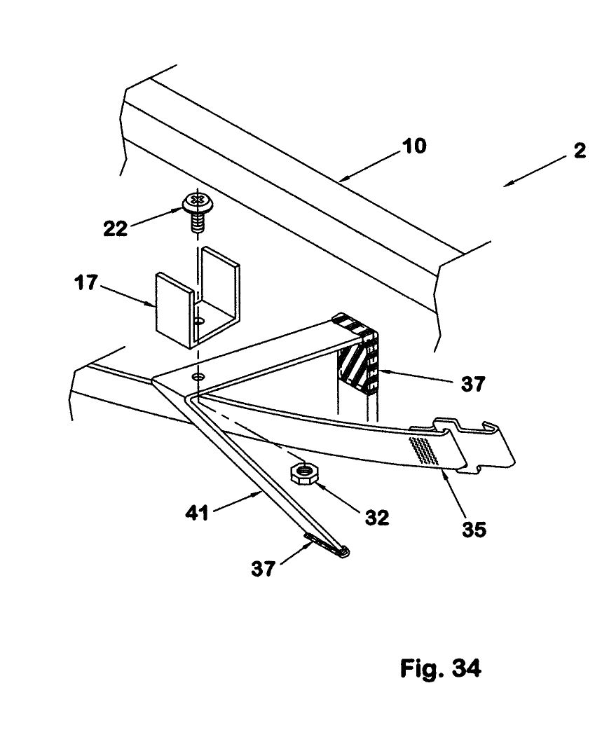

Referring to FIG. 33, the mounting arrangement 2 includes a bolt 15, spacer 18, a washer 40, and a nut 32 which hold the pivot arm 10 to a bracket (41) at the left end of the device. Plastic coating 37 on bracket 41 protects the vehicle while a strap 35 holds bracket to the vehicle, e.g., by engaging the left-hand edge of a rear door of the vehicle. Referring to FIG. 34, a bolt 22 and a nut 32 hold a guide bracket 17 to a second bracket 41 on right end. The second bracket supports the main telescoping arm 10.

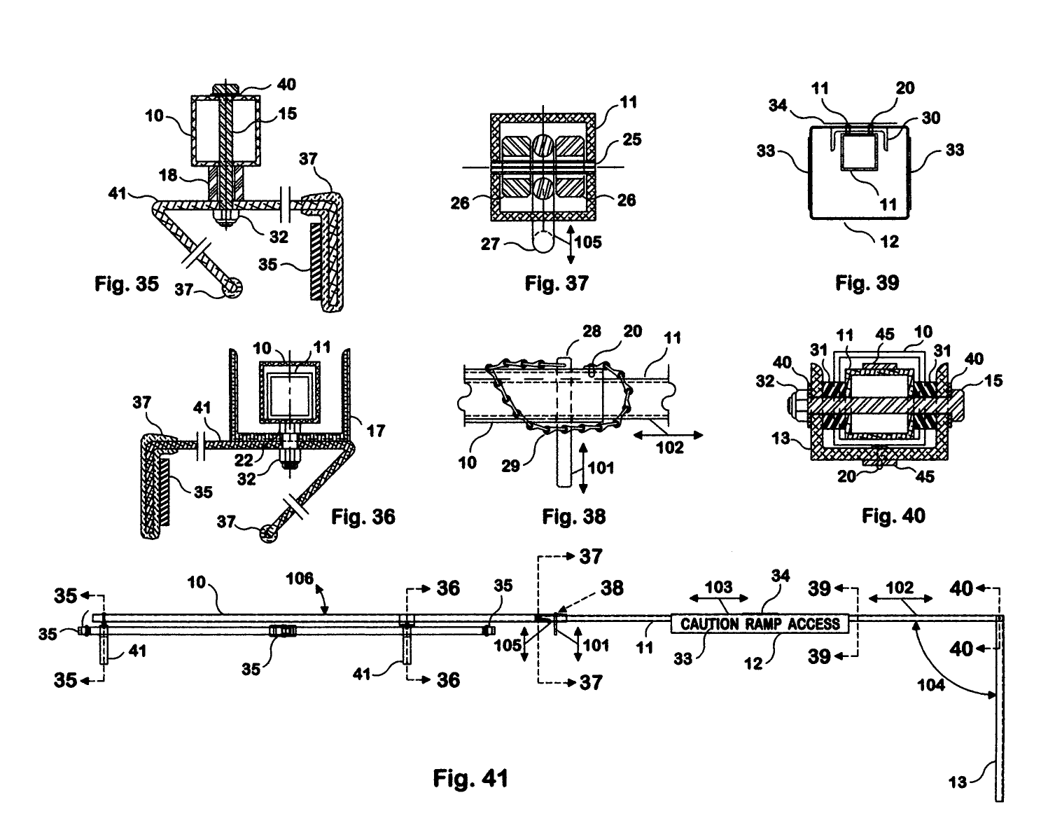

FIG. 35 is a cross-section of the device of FIG. 32 taken along the lines 35-35 of FIG. 41. FIG. 36 is a cross-section of the device of FIG. 32 taken along the lines 36-36 of FIG. 41.

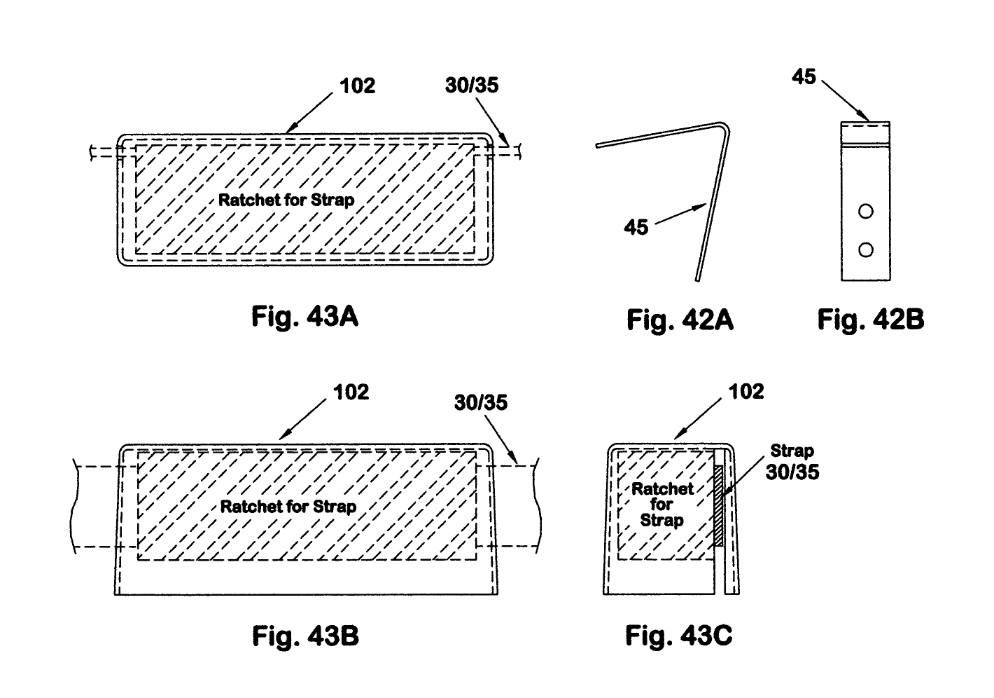

FIG. 37 is a cross-section of the device of FIG. 32 taken along the lines 37-37 of FIG. 41. FIG. 38 is a detail of the device of FIG. 32 showing the locking pin that secures the telescoping arm in the deployed condition. FIG. 39 is a cross-section of the device of FIG. 32 taken along the lines 39-39 of FIG. 41. FIG. 40 is a cross-section of the device of FIG. 32 taken along the lines 40-40 of FIG. 41. FIG. 41 is an elevation view of the device of FIG. 42 in the deployed condition. Insofar as FIGS. 37-41 are concerned, the design and method of operation is essentially the same as the other embodiments and a detailed description is omitted for sake of brevity. Like reference numbers refer to like elements in the various views. The description of FIGS. 2A-2C also applies to this embodiment.

Operation: All Models

The lift guard 1 is fastened or otherwise secured to the rear of the vehicle using the attachment mechanism 2 and the arm 10/11 is in a stowed or nested condition.

To Open (deploy):

1. Pull locking pin 28 up. (101 in the Figures).

2. Move slide arm 11 out to main pivot arm 10 to extended condition. (102)

3. Rotate pivot arm 10 up to deploy sleeve. (106) Return arm 10 to horizontal position.

4. Slide sleeve 12 with warning sign(s) onto slide arm 11. (103)

5. Pivot the vertical support or leg 13 down to vertical position. (104)

6. Stop pin 27 drops in place into slide arm at the end of extension. (105)

7. Secure the locking pin 28.

The lift guard is now deployed to the side of the vehicle as shown in FIG. 1 and access along the passenger side to the wheelchair lift is preserved due to the extension of the arm away from the side of the vehicle as shown in FIG. 1.

To Close:

1. Pull locking pin 28 up.

2. Push stop pin 27 up

3. Move slide arm 11 in such that it is nested within the pivot arm 10.

4. Rotate pivot arm 10 up.

5. Slide sleeve 12 back on pivot arm 10.

6. Fold leg 13 up, move slide arm 11 in until it stops.

7. Leg 13 fits inside of sleeve 12.

8. Replace locking pin 28.

The Lift Guard is now in a stowed or closed position. The vehicle can be driven away from the parking site in the usual manner with the Lift Guard remaining attached to the vehicle and ready to be deployed again.

Further Considerations

The lift guard can be made from aluminum, stainless steel, plastic and nylon components which prevent it from rusting and keep the total weight of the device light, under 6 pounds in most cases.

The caution signs 33 and 34 on the “CAUTION” sleeve 12 positioned on the slide arm 11 alerts drivers from both directions, i.e., it has a cautionary sign placed on opposite sides of sleeve 12.

The Lift Guard, designed with multiple mounting configurations, adapts to any van: Model TR (tire rack version).

Uses a mounting bar and U-bolts to attach to an existing tire rack mounted on the vehicle. (Shown in the drawings)

### Model SSD (Strap Single Door)

Uses a 5′ cargo strap and plastic coated brackets to attached unit to a single back door vehicle. (shown in the drawings)

### Model SSD-V (Velcro Pads)

This is a variant of the SSD model and uses longer brackets attached to the vehicle with Velcro, no strap.

### Model SDD (Strap Double Door)

This model uses a 2½ cargo strap, plastic coated brackets and is attached to left side back door. Some door modification required.

### Model SDD-V (Velcro Pads)

This model uses longer brackets attached to the vehicle with Velcro, no strap. No modification required.

### Model SCD (Strap Curved Door)

Uses longer plastic coated brackets to compensate for curved door, attached with 5′ cargo strap.

### Model SCD-V (Velcro Pads)

Uses longer brackets attached with Velcro, no strap.

### Model SC (Suction Cup)

Uses suction cups in place of brackets and straps. Requires additional door clips with safety cables.

All models above can be installed and removed from vehicle if desired at any time.

The embodiments that use a cargo strap 30/35 will typically also use a ratchet to tighten the strap. The vehicle is protected from scratches from the ratchet by means of a protective vinyl or plastic cover 102, shown in FIGS. 43A-43C.

The lift guard of this disclosure can be automatically deployed and retracted by means of a motor, e.g., powered by vehicle power. Several configurations are envisioned, including vertical stow and horizontally deploy and horizontally stow and horizontally deploy operation.

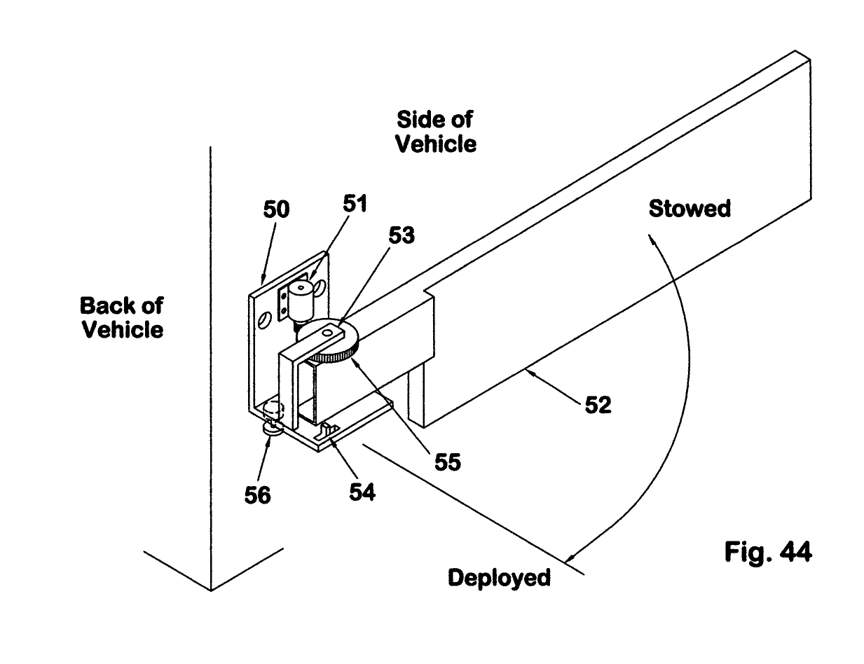

A horizontal stow and horizontal deploy electric motor option is shown in FIG. 44. In this embodiment, the design includes a mounting bracket 50, a 12 volt DC stall motor 51 powered by vehicle power, a mechanical stop 54 at two locations to limit travel of the arm 52 to 90 degrees, a caution arm 52 (similar to the telescoping arm 10/11) with a pressed on gear 55, and support brackets 53 for a pivot pin in the end of the arm 52. The design features a push button switch 56 for activation of the motor. A unit enclosure (not shown) is included to protect the motor and other electrical components from the weather. When the user activates the switch 56, the motor 51 is energized by vehicle power to rotate the arm 52 from a stowed position along the passenger side of the vehicle to a deployed position in which the arm is in the extended configuration as shown in FIG. 1. The arm 52 can take the form of the telescoping arm 10 of FIGS. 1A-1D and can include a nested slide arm 11, caution sleeve 12, and vertical support leg 13 as shown in the previous Figures.

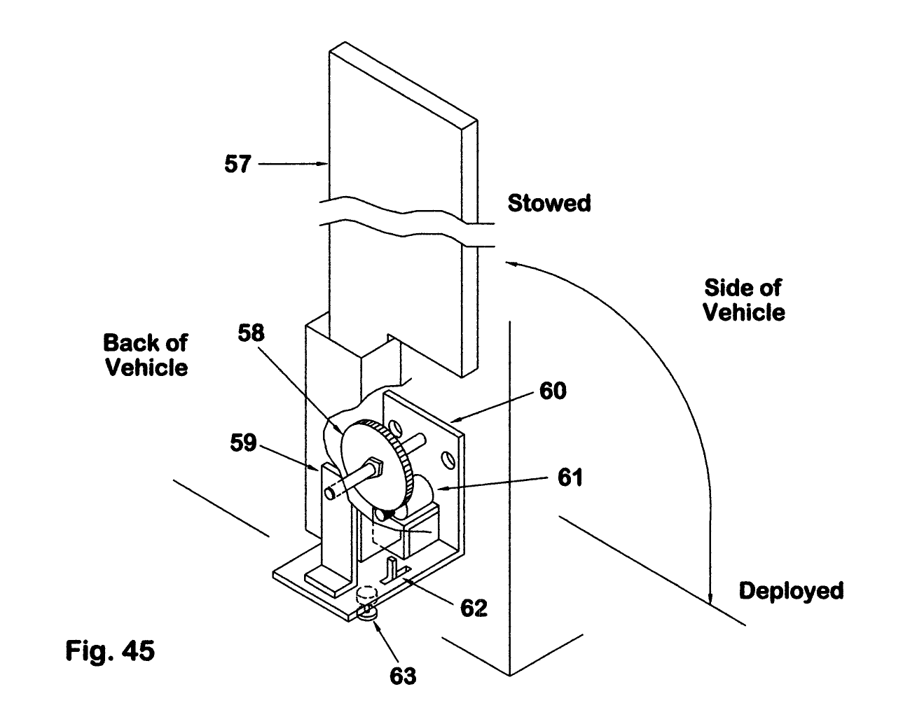

A vertical stow and horizontally deploy electric motor option is shown in FIG. 45. In this embodiment, a mounting bracket 60 mounts a motor assembly to the vehicle. The motor assembly includes a 12 Volt DC stall motor 61 powered by 12V vehicle power. Mechanical stops 62 are stamped from the bracket in two positions to limit travel of a main telescoping arm 57 to 90 degrees. The arm 57 includes a pressed on gear 58 at its proximal end. A support bracket 59 receives a pivot pin in the end of the arm 57 extending from the gear 58 as shown in the FIG. 45. The device features push-button operation by means of a manual switch 63 mounted to the bottom of the bracket 60. A unit enclosure, not shown, protects the components from the weather. Activation of the push button switch 63 causes the motor 61 to be energized by vehicle power to rotate the arm 57 from the vertical stowed condition to a horizontal deployed condition. The arm may be constructed in the same form as the telescoping arm 10 in the previous figures and include the nested slide arm 11, sleeve 12 and vertical support 13 as explained above.

An optional configuration of these embodiments includes a change in the motor 51 and 61 to a 120 Volt AC reversible motor via a DC to AC converter, using vehicle power. The arm 52/57 is then both deployed and retracted by means of the motor. The design may use electrical limit switches in place of mechanical stops to restrict the amount of rotation of the arm 52/57.

Additional optional design features include:

1. Manually disengage the motor from the arm in the event of a power failure to enable the user to manually stow the arm 57.

2. Provide a break-away arm “knuckle” or joint in the arm 57. If the arm is hit, the arm will fall away from the unit but can be popped into place afterwards.

3. LCD or LED technologies can be used to illuminate the CAUTION sign on the sleeve 12. This remark of course applies to the embodiments of FIGS. 1A-1D as well as that FIG. 45.

4. A gear box can be incorporated if desired to control the speed of the arm movement.

5. The pressed-on gear can be replaced by adding a linkage rod to the motor shaft and the other end sliding through an eyelet on the arm.

6. Rack and pinion drive arrangements are another possible configuration of the motorized embodiments.

7. The elevation of the arm 10 should be at least 36 inches off the ground in the deployed condition for maximum visibility.

8. A motion sensor can be mounted to the vehicle or the lift guard, which senses nearby passing cars. When motion is detected the caution sign is illuminated. For example, lights built into the sleeve 12 are energized from vehicle power or a portable power source (batteries) included in the lift guard 1.

### TERMINOLOGY

The term “caution sign” (described above as part of the sleeve 12), as used in the claims, should be interpreted to encompass a sign with printed verbiage such as CAUTION—LIFT ACCESS or the like, as well as signs that consist of purely non-verbal indicia or elements, as well as signs that combine verbal and non-verbal elements. For example, the “caution sign” could simply take the form of reflective barrier tape or painted reflective material applied to the arm or sleeve or both.

While presently preferred embodiments have been described with particularity, variations of the embodiments can of course be made without departure from the scope of the invention. All questions concerning scope are to be answered by reference to the appended claims.

We claim:

1. A device for reservation of access space for a vehicle equipped with a wheelchair ramp, comprising:
an attachment mechanism for attachment of the device to the vehicle;
an arm coupled to the attachment mechanism; and
a caution sign carried by or present on the arm;
wherein the arm is moveable from a stowed condition to a deployed position, the arm in the stowed condition while the vehicle is driven over the road and the arm moveable to the deployed condition when the vehicle is parked to thereby preserve space adjacent to the vehicle for access to the wheelchair ramp.

2. The device of claim 1, wherein the arm comprises a telescoping arm having a first arm coupled to the attachment mechanism and a slide arm nesting within the first arm and extendable relative to the first arm, the slide arm having a distal end portion, the device further comprising a vertical support attached to the distal end portion of the slide arm.

3. The device of claim 1, wherein the attachment mechanism is adapted to attach to a tire rack fitted to a rear door of the vehicle.

4. The device of claim 1, wherein the attachment mechanism is adapted to attach to one or more rear doors of the vehicle.

5. The device of claim 4, wherein the attachment mechanism comprises a strap and a mounting bracket arrangement affixed to one or more rear doors of the vehicle.

6. The device of claim 1, wherein the attachment mechanism is configured to enable the arm to pivot relative to the vehicle between vertical and horizontal positions.

7. The device of claim 1, wherein the arm comprises a telescoping arm.

8. The device of claim 1, further comprising an electric motor assembly coupled to the arm for moving the arm between the stowed and deployed condition.

9. The device of claim 8, wherein the arm, in the stowed condition, is positioned along the passenger side of the vehicle and the motor moves the arm to a deployed condition extending substantially away from the passenger side of the vehicle to thereby reserve space along the side of the vehicle.

10. The device of claim 8, wherein the arm, in the stowed condition, is positioned along the passenger side of the vehicle and wherein the motor moves the arm to a deployed condition extending substantially away from the passenger side of the vehicle to thereby reserve space along the side of the vehicle.

11. The device of claim 9, wherein the arm comprises a telescoping arm.

12. The device of claim 1, wherein the caution sign is illuminated.

13. A method of preserving access space for a vehicle equipped with a wheelchair ramp, comprising the steps of:
stowing an access space reservation device on or in the vehicle while the vehicle is driven over the road, the device including an extendable arm and a caution sign,
upon parking the vehicle, deploying the extendable arm such that the arm is extended away from the vehicle a sufficient distance to preserve access space for the wheelchair ramp, and
displaying the caution sign.

14. The method of claim 14, wherein the caution sign is affixed to a sleeve that slides over the arm, and wherein the displaying step comprises the step of displaying the sleeve with the caution sign affixed thereto.

15. The method of claim 14, further comprising the step of illuminating the caution sign.

16. The method of claim 14, wherein the step of deploying is accomplished by means of a motor.

17. The method of claim 16, wherein the motor is powered by vehicle power.

18. The method of claim 16, wherein the motor operates to move the arm from a horizontal stowed position to a horizontal deployed position.

19. The method of claim 16, wherein the motor operates to move the arm from a vertical stowed position to a horizontal deployed position.

20. The method of claim 14, wherein the arm comprises a telescoping arm.
